(19) United States
(12) Patent Application Publication
(10) Pub. No.: US 2022/0298012 A1
(43) Pub. Date: Sep. 22, 2022

(54) Mantle peridotite based-activated carbon nanosheet:catalyst for cathode oxygen reduction of seawater to generate hydrogen (H) when exposed to sunlight using the photocatalytic water splitting

(71) Applicant: Teresita Amponin Canuto, Van Nuys, CA (US)

(72) Inventor: Teresita Amponin Canuto, Van Nuys, CA (US)

(21) Appl. No.: 17/300,125

(22) Filed: Mar. 18, 2021

(51) Int. Cl. C01B 3/04; B01J 19/12; B01J 23/02; B01J 35/00

(52) U.S. Cl. CPC C01B 3/042; B01J 19/127; B01J 23/02; B01J 35/004; B01J 2219/0877; B01J 2219/0892; B01J 2219/1203

(57) ABSTRACT

The mantle peridotite based-activated carbon nanosheet is a catalyst for cathode oxygen reduction of seawater to generate hydrogen when exposed to sunlight (photocatalytic water splitting). The catalyst is placed in the top surface of seawater and when exposed to sunlight begins to generate hydrogen (H⁺). The catalyst mantle peridotite based-activated carbon nanosheet and the sunlight combine generate electricity, mix with seawater splits the seawater significantly generates hydrogen (H⁺) from the seawater. The hydrogen is collected and stored in the cathode. From the cathode the collected gas is transferred to the hydrogen storage tank.

### BACKGROUND OF INVENTION

This invention relates to hydrogen (H⁺) production using mantle peridotite based-activated carbon nanosheet as catalyst for cathode oxygen reduction of seawater to generate hydrogen(H⁺) when exposed to sunlight using the photocatalytic water splitting.

It is the goal of this invention to eventually move us toward a future powered by renewable energy that is truly clean, or toward a clean-energy future requires a zero emission fuel source that is low cost, efficient and abundant source of hydrogen(H⁺) from seawater.

As stated in “Hydrogen Storage in Nanotubes and Nanostructures” by George E. Froudakis
“Two of the most significant problems that humanity will have to face over the next 50 years are the environmental and the energy problems. The second is ranked by experts as the most important and difficult to solve. These problems are connected, since traditional fossil fuels are responsible for air pollution thanks to the CO₂ they produce during combustion. The linear increase of the world population over the last several hundred years is leading to an analogous linear demand in energy. Unfortunately this has resulted in an exponential increase of global fossil carbon emission over the last several decades, and the same trend appears for the global temperature. It is also clear that the over consumption of fossil fuels will lead to their exhaustion very soon. From all'the observations it is obvious that these two major global problems concerning energy and environmental must be faced together, and the simplest solution to both problems is the replacement of gasoline with an environmentally fuel like hydrogen.”

To produce hydrogen(H⁺) to be usable as fuel, a catalyst is needed for hydrogen generation. Sunlight is an abundant resource. When exposed to water (H₂O) molecules can be split into hydrogen and oxygen with the addition of energy. In chemistry, its called a catalyst. A catalyst lowers the amount of energy needed for two compounds to react. Some catalysts function only when exposed to light.

To get hydrogen(H⁺) out of the water a catalyst is mix for cathode oxygen reduction. The catalyst for cathode oxygen reduction of seawater is mantle peridotite based-activated carbon nanosheet that has material chemistry electrode properties (e.g. the nanosheet is a carbonaceous material), is placed on top of the seawater surface upon exposure to sunlight, the mantle peridotite based-activated carbon nanosheet produces hydrogen. The hydrogen (H⁺) is collected and stored by the cathode. A vacuum pipe is connected to the cathode. A host material is attached to the vacuum pipe to transfer the stored hydrogen from the cathode to the hydrogen storage tank.

### SUMMARY OF INVENTION

Accordingly, an object of the present invention is to provide a low cost, efficient and abundant source of hydrogen (H⁺) from seawater using the photocatalytic water splitting for hydrogen production. In photocatalytic water splitting seawater is the source of hydrogen. Water molecules can be split into hydrogen and oxygen with addition of energy. To get hydrogen out of the water, a catalyst for cathode oxygen reduction from material chemistry electrode properties is exposed to sunlight. Exposure to sunlight of the catalyst mantle peridotite based-activated carbon nanosheet produces hydrogen which is collected and stored at the cathode.

Some catalyst in producing hydrogen are very expensive such as titanium dioxide, platinum, and rhenium. Platinum is very expensive metal (over US $1000, per ounce), while rhenium cost around $70 an ounce. These metals are not suitable for large scale application because they are rare in earth's crust. To become a good catalyst, it should meet the many requirements such as low cost, recyclable, efficient, long lasting, scalable, suitable in reaction and environment, has appropriate electronic structure and abundant. If the material is most common in earth's crust, the most abundant, catalyst is the cheapest. The mantle peridotite based-activated carbon nanosheet is the solution in the replacement of the very expensive catalyst.

### DETATLED DESCRIPTION OF INVENTION

A catalyst for cathode oxygen reduction of seawater to generate hydrogen (H⁺) using the photocatalytic water splitting is the mantle peridotite based-activated carbon nanosheet. The nanosheet is a synthesis of carbon nanotubes (CNTs) from the novel material composed of mantle peridotite based-activated carbon.

Upon CO₂ capture of the mantle peridotite glass cells or photovoltaic cells, carbon mineralization occur to the peridotite glass cells (e.g. Mg⁺-rich, CA bearing, and rich also in olivine and pyroxene materials). The carbon mineralization mantle peridotite is the peridotite carbon mineralization-based which is the based-activated carbon for synthesis of carbon nanotubes.

The catalyst mantle peridotite based-activated carbon nanosheet is placed in the top surface of seawater. The catalyst is attach to the cathode tube serves as a storage for the hydrogen collected from the catalyst. The cathode tube storage is made up of aluminum metal with half of the tube flattened. An electrode or wire from the cathode tube connects the copper metal. The copper metal serves as 1) clip that hold the nanosheet (2) cathode that pulls electrons from the catalyst.

The cathode tube has installed temperature controller called the Watlow's PM Plus temperature controller. The PM Plus limit or controls the temperature of the heat power of the cathode tube. The PM Plus is remotely set up, has a picture of panel temperature control. The PM Plus temperature controller has an easy programming of temperature set-up the heat power with the bluetooth connectivity with the E-Z link mobile app for remote access capability and full descriptions of parameters and error codes.

The catalyst and cathode tube slowly dropped down in the seawater with the help of the fixed pulley. The string of the pulley remained attached to the strings holding the catalyst/cathode tube while floating in the seawater top surfaces. The catalyst remains when exposed to sunlight generates hydrogen from water. Exposure to light the catalyst produces hydrogen, oxygen. The sunlight combine with catalyst generate electricity, mix with seawater splits the seawater to generate hydrogen. The catalyst causes the separation of hydrogen from oxygen. The hydrogen atom bonds to carbon of the nanosheet. The hydrogen atom attached separates from carbon when sunlight heats the catalyst. It separates the hydrogen from the carbon. The sodium (Na⁺) element of seawater bound to carbon of the catalyst too while the chloride (Cl⁻) and oxygen (O₂) get oxidized and lose electron. The hydrogen and sodium are reduced and gain electrons. Then, the copper metal pulls the electrons from the catalyst, an electrode or wire connected to copper metal moves the electrons from the cathode (copper metal) into the cathode tube storage. The cathode tube storage has a fully autoshgt-off mechanism when full tank with hydrogen. The cathode tube is equipped with radar device readable via USB or SD card build IDDA power ¼″ 20 thread to 6 AA battery. The working mode can be online or SD card offline. A task scheduler app is set up in the laptop or Iphone for basic task such as 1) start (2) finish or auto shut-off. The app is also installed to the cathode tube to mirror if the appliance has auto shut-off when full tank. A red led light in the cathode tube turns off when the cathode tube auto-shut-off. The laptop or Iphone and cathode tube storage connect with the same WIFI connection or network connection. A sim card is placed in the slot of the cathode tube to connect it to the laptop or Iphone.

After the collection of hydrogen the fixed pulley pulls up the catalyst and cathode tube storage out of the water and transfer in the boat. The pulley is mechanically controlled. The cathode tube storage has a vacuum pipe wherein a host material is attached to the vacuum pipe to suction the hydrogen and transfer the gas to the cylinder tank or hydrogen storage tank.

### SPECIFICATION OF DRAWINGS

FIG. 1

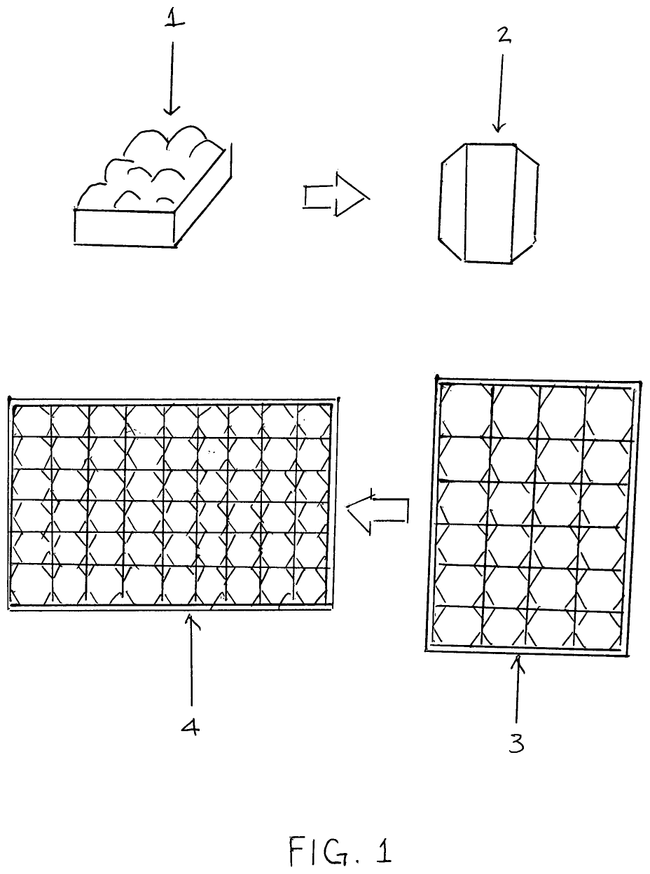

1) crushed mantle peridotite rock fragments

2) mantle peridotite glass cell (.e.g. crushed rocks melted and formed into glass cell)

3) mantle peridotite glass cell connected to form a glass cell panel)

4) glass cell panels interconnected with electrodes or wires

FIG. 2

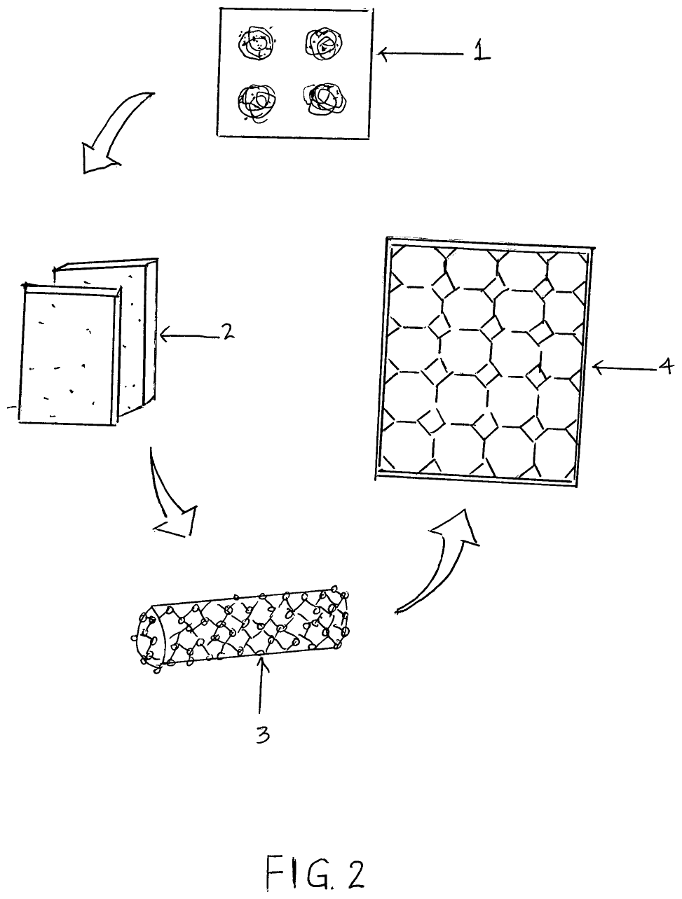

1) mineralized based-activated carbon powder

2) activated carbon pads

3) carbon nanotubes

4) mantle peridotite based-activated carbon nanosheet

FIG. 3

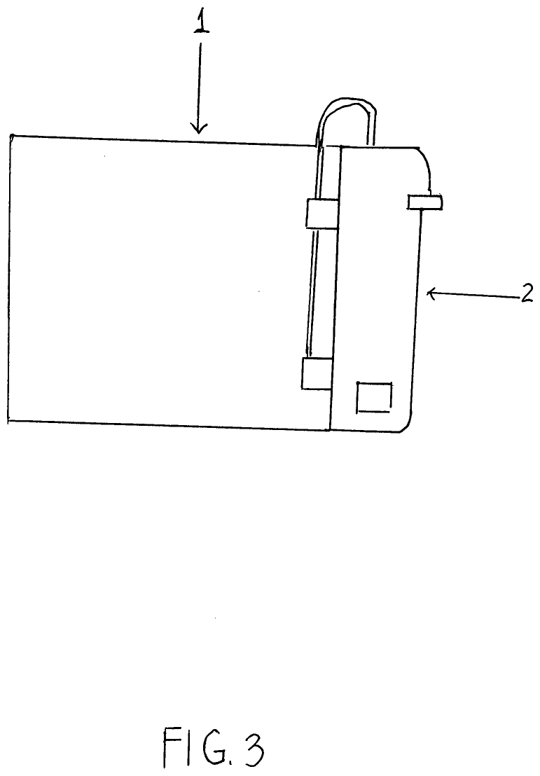

1) catalyst/mantle peridotite based-activated carbon nanosheet

2) cathode tube storage (made up of aluminum metal)

FIG. 4

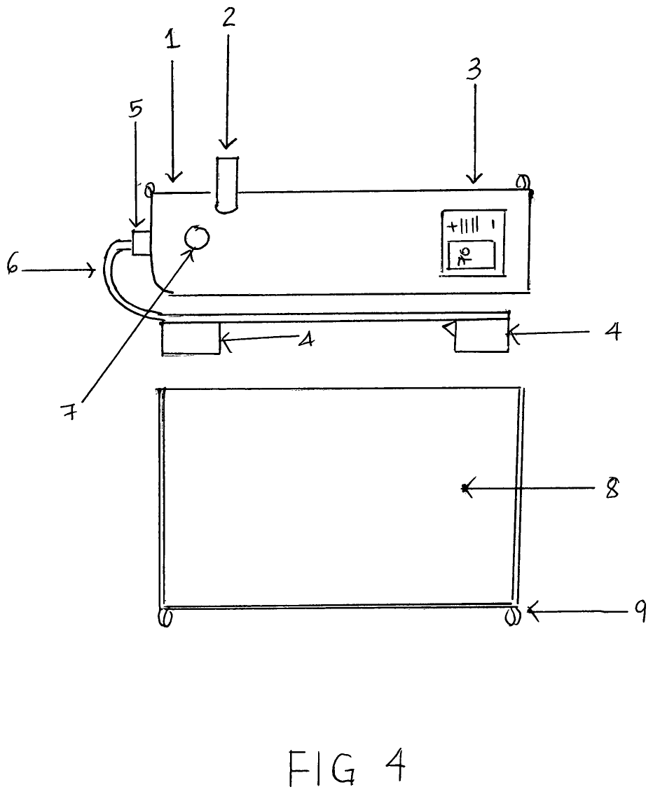

1) cathode tube storage

2) vacuum pipe

3) Watlow's PM Plus temperature controller

4) copper metal (cathode)

5) copper metal (cathode)

6) electrode or wire

7) red led light (turns-off when full tank)

8) catalyst carbon nanosheet

9) ring holder (holds the strings that connect to pulley)

FIG. 5

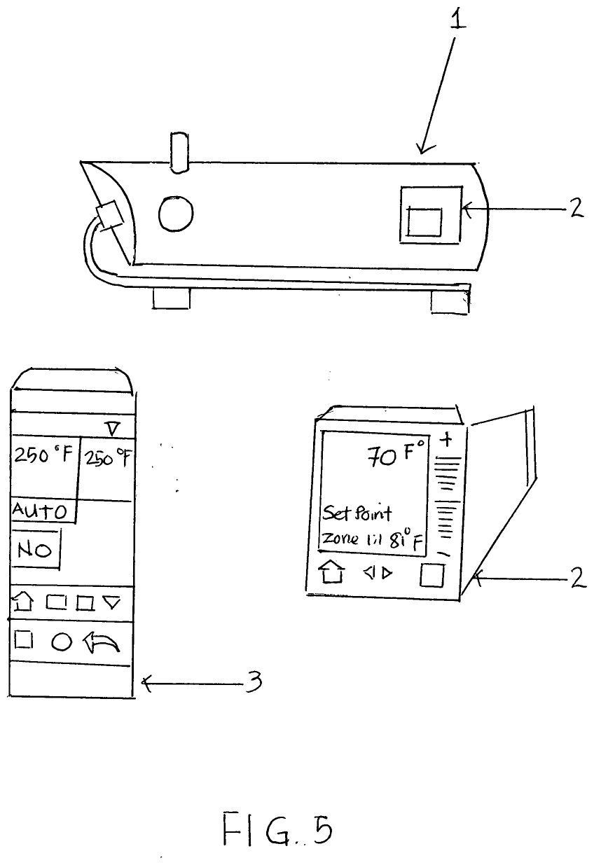

1) cathode tube storage

2) Watlow's PM Plus temperature controller

3) remote controller

FIG. 6

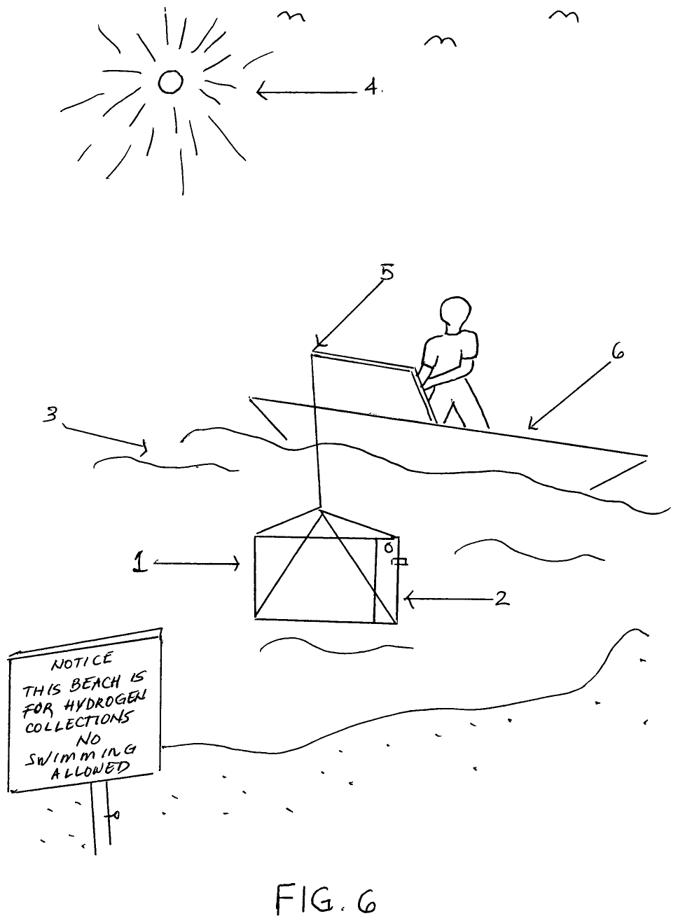

1) catalyst/carbon nanosheet

2) cathode tube storage

3) seawater

4) sunlight

5) fixed pulley

6) boat

FIG. 7

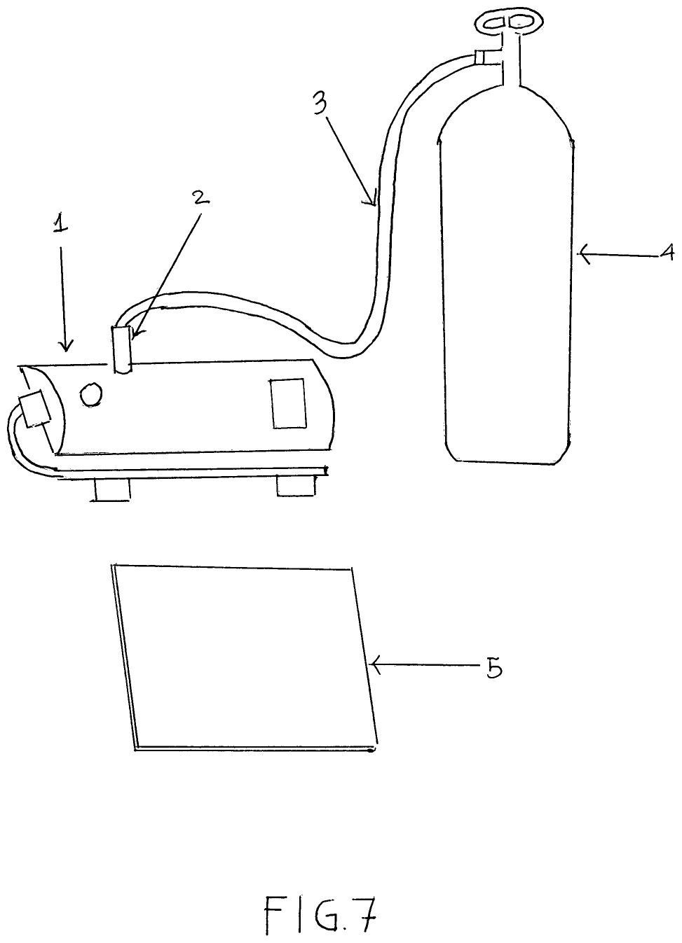

1) cathode tube storage

2) vacuum pipe

3) host material

4) cylinder tank (H⁺ storage tank)

5) catalyst/carbon nanosheet

What is claimed?

1. The present invention discloses an abundant source of hydrogen(H) that uses the photocatalytic water splitting with a catalyst for cathode oxygen reduction of seawater to generate hydrogen when exposed to sunlight.

2. Mantle peridotite based-activated carbon nanosheet is the catalyst for the photocatalytic water splitting.

3. The invention claims the technical and structural made up of the cathode tube storage that is equipped with Watlow's PM Plus temperature controller with remote control for easy temperature set-up. The PM Plus temperature connectivity uses the E-Z link mobile app for remote access.
